(19) United States
(12) Patent Application Publication
(10) Pub. No.: US 2004/0007552 A1
(43) Pub. Date: Jan. 15, 2004

(54) Mobile handling equipment for piece goods

(76) Inventors: Hermann Franzen, Monchengladbach (DE); Joachim Kroll, Juchen (DE)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/606,576

(22) Filed: Jun. 26, 2003

(30) Foreign Application Priority Data
Jul. 9, 2002 (DE) 102 31 911.1-22

(51) Int. Cl. B66C 23/06

(52) U.S. Cl. 212/232

(57) ABSTRACT

The invention refers to mobile harbor crane (1) for the handling of ISO containers from smaller container ships (3), with steerable wheel mechanism (4.1) with multiple axles and supports (4.2) telescoped laterally, as well as upper carriage (5) holding rigid tower (6), boom (7), drive aggregates and a counterweight, and connected to lower carriage (4) via a slewing gear. The new handling equipment is intended to make it possible to load and unload smaller container ships (3) efficiently and to connect different areas of a container terminal as an integrated component of an automated container terminal. According to the invention, boom (7) is articulated in the lower area of upper carriage (5)'s steel structure to accommodate luffing and holds at the tip of the boom, boom head (9), connected via parallelogram system (8), consisting of two pieces in a horizontal direction, that is an upper first part (9.1), connected to luffing boom (7) via parallelogram system (8), and a lower second part (9.2), connected with the upper part via a horizontal rotary connection (9.3.)

### BACKGROUND OF THE INVENTION

The present invention is directed to mobile handling equipment for piece goods and particularly to a mobile harbor crane. The invention is specifically adapted to handle ISO containers from smaller container ships, and consists of a lower carriage on a steerable wheel mechanism with multiple axles and supports that can be telescoped laterally, as well as an upper carriage which is the base for a luffing boom with a load-handling device mounted on it. The upper carriage holds a rigid tower, drive aggregates and a counterweight and is connected to the lower carriage via a slewing gear.

Mobile harbor cranes are typically used in seaports and inland ports to handle piece goods, specifically ISO containers, and frequently in “stand-by” operations next to container bridges. The mobility of these mobile harbor cranes requires environment conditions usually met by manually operated container terminals.

The transport width of a known mobile harbor crane is defined by the dimensions of its telescoped support bases, its transport height by the angular position of its boom. When moving the equipment with the boom raised, the boom will be located at an angle necessary for even axle load distribution with regard to the tower firmly mounted on the upper carriage. In order to change the equipment's position, a procedure is known in which its boom is laid down, as it supports itself on the wharf with one wheel located at the tip of the boom. Even with the boom laid down, the height of passage determined by the height of the rigid tower is very large with this type of procedure, so that passage through the portal of a container bridge, for instance, is not possible. In this case, a separate lane must be available next to the container bridge's track.

Mobile harbor cranes are basically supposed to reach their assigned positions at a wharf quickly and with extreme mobility with the least amount of space required. Equipment meeting these requirements can be used particularly efficiently when loading, respectively unloading even small container ships such as barges and feeders (a capacity of up to 400 TEU.) Most of all, they may become an integrated part of an automated container terminal, i.e., superordinate terminal logistics monitor the loading and unloading process, while the mobile harbor crane can deposit its load automatically in a defined orientation at predetermined storage positions.

Thus far, known mobile harbor cranes do not presently meet the described criteria, specifically the option of automation. As the load-handling device for ISO containers, a so-called spreader is usually connected to the load hook of a pivoting traverse, and the pivoting traverse again is fastened to two hoisting ropes. This type of suspension is very susceptible to oscillation and twisting of the load, especially when containers are loaded asymmetrically or in a “twin lift” operation (two 20 ft. containers). As the exact and fast positioning of a load typically depends on the skills of the crane operator, automated use is not possible with known mobile harbor cranes. Though the use of additional equipment, such as a spreader suspension with gravity compensation and/or electronically damped oscillation, provides support to the crane operator, it does, however, create additional expenditures and increases inefficiency.

It is the task of the invention at hand to create new handling equipment for piece goods based on the described problems and disadvantages with the current state of technology, founded on the known technology of mobile harbor cranes with a wheel mechanism, and to lead to efficient loading and unloading of smaller container ships specifically. The new device is, therefore, intended to become an integrated part of automated container terminals and to be in a position to connect a container terminal's different areas with each other, while working with transportation systems without operators. The device is intended to be able to reach its position quickly and with extreme mobility with the least amount of space required and is intended to be able to deposit its load automatically in a precisely defined orientation at predetermined storage positions.

### SUMMARY OF THE INVENTION

A mobile harbor crane, characterized in that the boom in the upper carriage's lower section is articulated at its steel structure to accommodate luffing and has at the tip of the boom a boom head, at which the load-handling device is fastened via hoisting ropes, is recommended as a solution to this task according to the invention. In a rather known type of construction of the lower carriage, different from conventional archetypical mobile harbor cranes where the boom is articulated at the tower, the upper carriage's steel structure becomes the base for the location of the boom. The upper carriage, furthermore, carries an engine house with a drive aggregate, a slewing gear with a rotary connection, two double hoist winches, a double luffing winch, a boom support, an e-room, a counterweight and the known tower firmly connected with the upper carriage via a flange connection.

By articulating the boom in the upper carriage's lower section, the rigid tower can be designed lower, so that the mobile harbor crane's maximum height determined by the top of the tower and the rows of rope located there, can be essentially less. This makes it possible to also pass through the portal of a container bridge with an appropriately lowered boom without having a separate additional lane next to the track of the container bridge. Adjustment of the boom seated in the upper carriage's steel structure is accomplished via a luffing mechanism driven by ropes, a pre-stressed hydraulic spring brake system designated to be between the foot of the boom and the upper carriage is used as the boom support and provides a controlled damped luffing process, specifically in the boom's vertical position. If a hydraulic luffing mechanism is provided as an alternative, the boom support becomes unnecessary.

According to another characteristic of the invention, it is designated that the boom head be connected to the tip of the boom via a parallelogram system and remain oriented vertically and horizontally in any boom position via support poles or holding ropes during luffing.

In a special design of the invention, the boom head is made of two parts in a horizontal direction and consists of an upper first part connected to the luffing boom via a parallelogram system, and a lower second part connected with the upper part via a horizontal rotary connection. This boom head design makes it possible to pivot the lower part of the boom head with regard to the vertical upper part of the boom head, which is oriented horizontally in any pivoting position of the boom, so that the load-handling device mounted thereon can turn the piece goods into the desired position, for instance in order to turn the doors of a container or the cooling aggregates of cooling containers into a defined orientation during the loading and unloading process.

The boom head's lower part, which can pivot around a vertical axis of rotation, can preferably be pivoted via rotary drives by up to +/−135° with regard to the boom head's stationary upper part.

One especially favorable characteristic of the invention provides that, in order to raise and lower the load-handling device, a total of four hoisting ropes, which were reeved five times between the tower and the tip of the boom, are routed concentrically via four rolls of rope located at the tip of the boom to two pairs of rolls of rope located in the upper part of the boom head, of which one pair is arranged staggered above the other pair such that the four hoisting ropes run parallel and at the same distance to each other in a vertically central manner through the rotary connection to the load-handling device, where the hoisting ropes are routed via four vertically revolving deflector rollers star-shaped outwardly to one each of four additional deflector rollers, guiding the respective hoisting rope vertically to the top back to the pivoted lower part of the boom head, where the four hoisting ropes are fastened.

The hoisting ropes are reeved five times between the tower and the tip of the boom in order to achieve a horizontal path for the load while the boom is luffing. The total of four hoisting ropes is routed such that the vertical flow of the ropes results in a square with lateral length “z” from a horizontal sectional view of the hoisting ropes. At first, the four hoisting ropes running in the direction of the load traverse follow the four inner rolls of rope, which are located on the load traverse, positioned in an x-shape and run vertically, and are then routed back vertically to the rotary part of the boom, where the ropes' fixed points are located, running horizontally via four outer rolls of rope also located on the load traverse in an x-shape and running in a vertical direction. The four inner rolls of rope, which are arranged in an x-shape, are located on the load traverse such that the vertically running hoisting ropes also form a square with lateral lengths “z” from their vertical sectional view. This setup allows turning the boom head by approximately +/−135°.

As an alternative to the aforementioned solution, it is suggested that in order to raise and lower the load-handling device, a total of four hoisting ropes, which have preferably been reeved three times concentrically via four rolls of rope located at the tip of the boom, are routed to two pairs of rolls of rope located in the upper part of the boom head. From the two pairs of rolls of rope, one pair is staggered above the other pair such that the four hoisting ropes run parallel and at the same distance to each other vertically central through the rotary connection into the lower part of the boom head, where the hoisting ropes are routed via four vertically revolving deflector rollers in a star-shape outwardly to one each of the four additional deflector rollers, routing the respective hoisting rope vertically downward to one of the load-handling device's vertices.

Reeving the hoisting ropes three times in order to obtain a horizontal path of the load during the boom's luffing is part of the current state of technology. A total of four hoisting ropes are routed such that the vertical flow of the rope results in a square with lateral length “z” from a horizontal sectional view of the ropes.

Two planes located on top of each other are followed by a total of eight rolls of rope arranged in an x-shape in the rotary lower part of the boom head. The four hoisting ropes run concentrically on the first plane to the four rolls of rope, which are arranged in an x-shape. The rolls of rope are positioned such that the vertically running ropes also form a square with lateral length distance “z” from a horizontal sectional view. This layout and a sufficiently large distance of the rolls of rope in the upper luffing part with regard to the rolls of rope in the lower rotary part also permit turning the boom head by approximately +/−135°.

One design of the invention provides that the distance between the lower of the two pairs of rolls of rope, which are located in the upper part of the boom head and the four vertically revolving deflection rollers, located in the lower part of the boom head, is selected such that the permitted diversion of the rope does not exceed ≦4° when turning the lower part of the boom head. This permitted rope diversion, for instance, is stipulated in DIN 15020, page 1.

If, according to another characteristic of the invention, the boom with the articulated boom head is pivoted into a lower transport position, in which the tip of the boom is located below an assumed horizontal plane, which comes in contact with the top of the mobile harbor crane's tower, then the top of the tower also constitutes the dimension for the equipment's maximum height of passage. However, it is significantly lower than with conventional equipment. As the boom head remains in a defined working position even when the boom is lowered, the equipment may, for example, pass through container bridges and, therefore, exhibits extreme mobility.

In order to increase the support base as the equipment is moved, another characteristic of the invention provides that the wheel mechanism's axles are arranged asymmetrically with regard to the lower carriage, as it pertains to the center of the slewing gear. Such an orientation occurs in the equipment's direction of travel, being that those axles or that axle of the equipment in whose direction the boom is lowered, continue(s) to protrude further beyond the upper carriage than the remaining axles.

It is designated that there be preferably eight axles divided at a ratio of four to two+two, and that the boom can be lowered in the direction of axle group two+two in order to move the equipment.

The new mobile harbor crane exhibits many advantages. As the new equipment is not bound by a track, it can change its location at the wharf at any time and can be integrated into the operation of an automated container terminal. As the equipment according to the invention has a relatively low height of passage compared to conventional mobile harbor cranes in transport position, no separate lane is required next to the container bridge's track. Most of all, the design of the boom head and the load-handling device makes it possible to systematically guide the load and have a defined load distribution. A mobile harbor crane of the suggested type of construction can be automated and can be integrated seamlessly into an automated container terminal.

These and other objects, advantages and features of this invention will become apparent upon review of the following specification in conjunction with the drawings.

### BRIEF DESCRIPTION OF THE DRAWINGS

One design example for the invention is shown in the drawings and is described as follows. Shown are:

FIG. 1 is a lateral view of an automated mobile harbor crane according to the invention;

FIG. 2 is a top view onto a mobile harbor crane according to FIG. 1;

FIG. 3 is an enlarged section of a boom and a boom head according to the invention;

FIG. 4 illustrates the boom head as the load-handling device is in a turned position;

FIG. 5 is a top view onto the boom head from FIG. 3;

FIG. 6 is a top view onto the boom head from FIG. 4;

FIG. 7 is a lateral view of a mobile harbor crane in transport position;

FIG. 8 is a back view of a mobile harbor crane also in transport position; and

FIG. 9 is an alternative routing of rope on a mobile harbor crane according to the invention.

### DETAILED DESCRIPTION OF THE PREFERRED EMBODIMENT

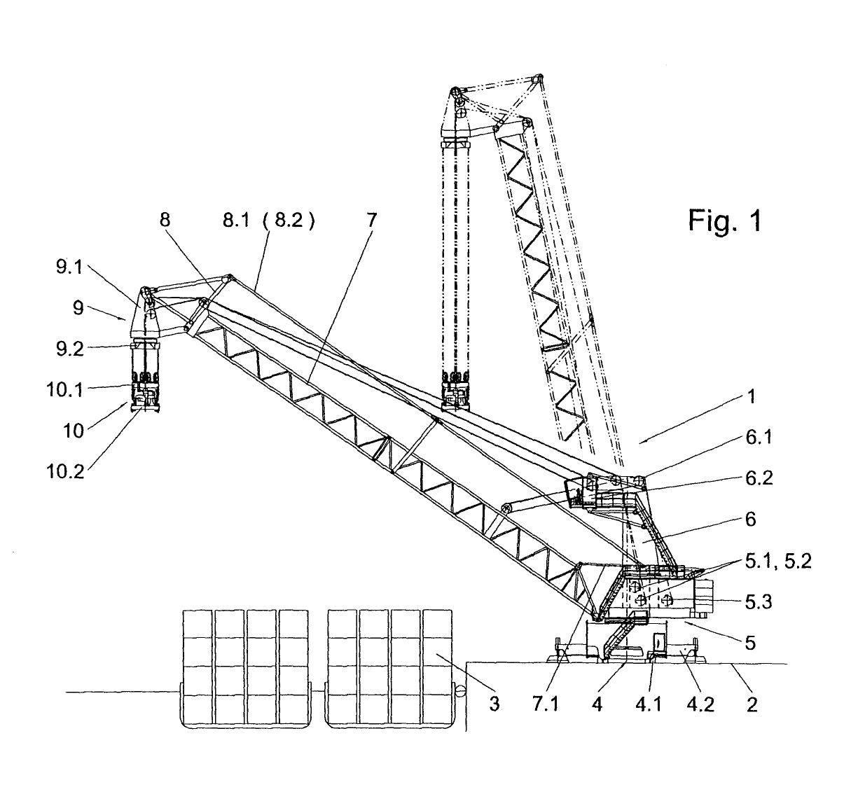

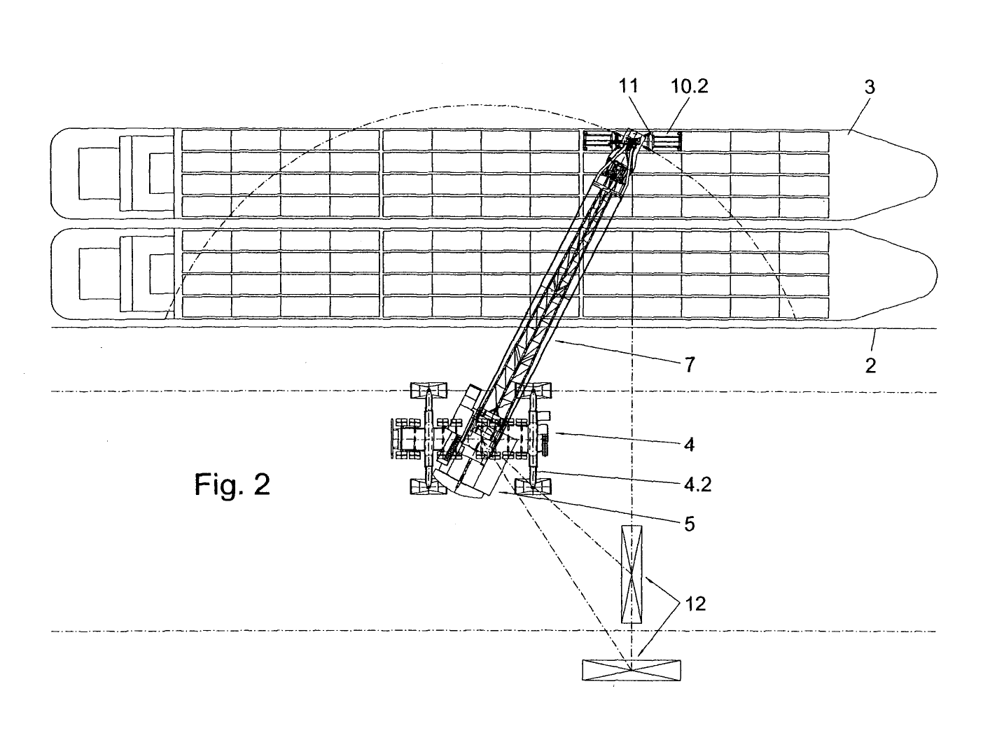

FIG. 1 shows mobile harbor crane 1 according to the invention in front of two barges 3 lying alongside wharf 2 from a lateral view. The mobile harbor crane's main components are lower carriage 4 with wheel mechanism 4.1 and support 4.2, upper carriage 5 with hoist winches 5.1 and 5.2 and luffing winch 5.3, tower 6 with deflection rollers 6.1 and cabin 6.2, boom 7 with boom support 7.1, parallelogram system 8 with support poles 8.1, luffing head 9 with luffing upper part 9.1 and lower part 9.2, rotary by contrast, as well as load-handling device 10 with load traverse 10.1 and spreader 10.2. In the top view of FIG. 2, the dash-dotted lines mark the work area of mobile harbor crane 1. The equipment supports itself on wharf 2 with the help of support 4.2, located at the front of lower carriage 4. Boom 7 located at the steel structure of upper carriage 5 is positioned such that spreader 10.2 is able to pick up predetermined container 11 from barge 3 and deposit it in a defined orientation parallel or at a right angle to the wharf at predetermined storage location 12, after turning the boom in the direction of the wharf.

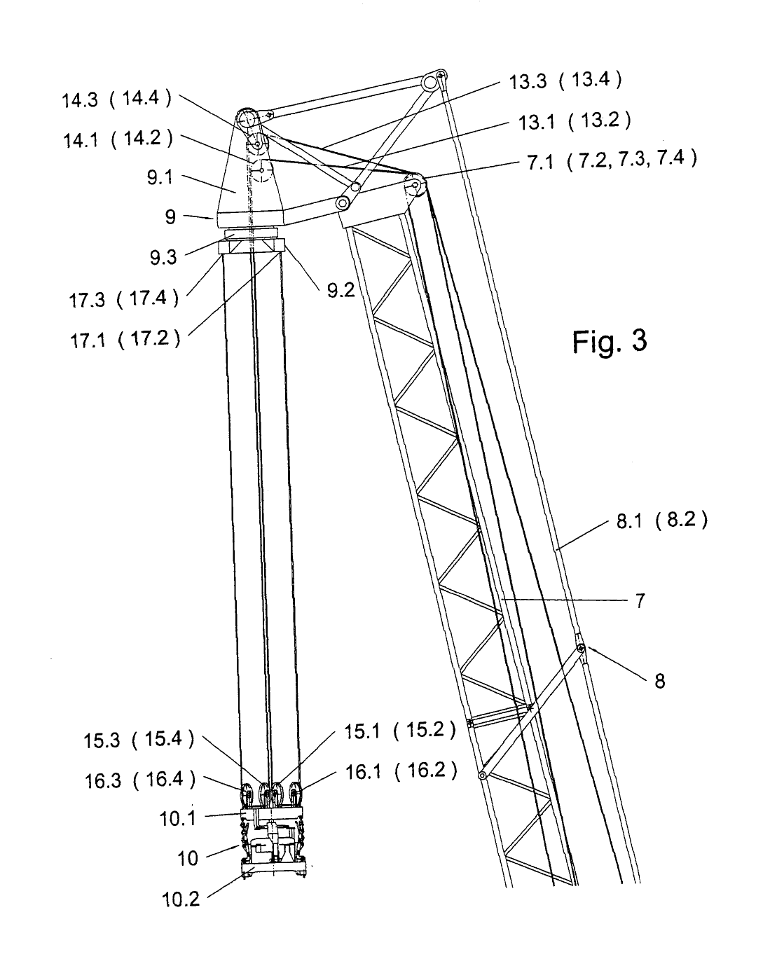

Drawing FIG. 3 shows an enlarged depiction of a section of the head area of boom 7 illustrated in FIG. 1. The boom is located in a vertical position; also shown are parallelogram system 8, a pair of support poles 8.1 and 8.2, luffing head 9 with luffing upper part 9.1 and rotary lower part 9.2, rotary mechanism 9.3 and load-handling device 10 with load traverse 10.1 and the spreader. Via the four rolls of rope 7.1-7.4, the four hoisting ropes 13.1-13.4 are routed vertically downward by means of two pairs of rolls of rope 14.1 and 14.2 as well as 14.3 and 14.4 in the direction of load traverse 10.1 and are directed via inner rolls of rope 15.1-15.4 fastened there and arranged in an x-shape. From there, the hoisting ropes are routed horizontally via outer rolls of rope 16.1-16.4 located on the same plane on load traverse 10.1 and arranged in an x-shape, and returned vertically to suspension points 17.1-17.4 on the rotary lower part 9.2 of boom head 9. The illustration in FIG. 3 contains rotary lower part 9.2 of boom 9 in a zero-degree position, therefore without rotary offset to the luffing upper part of boom head 9.1.

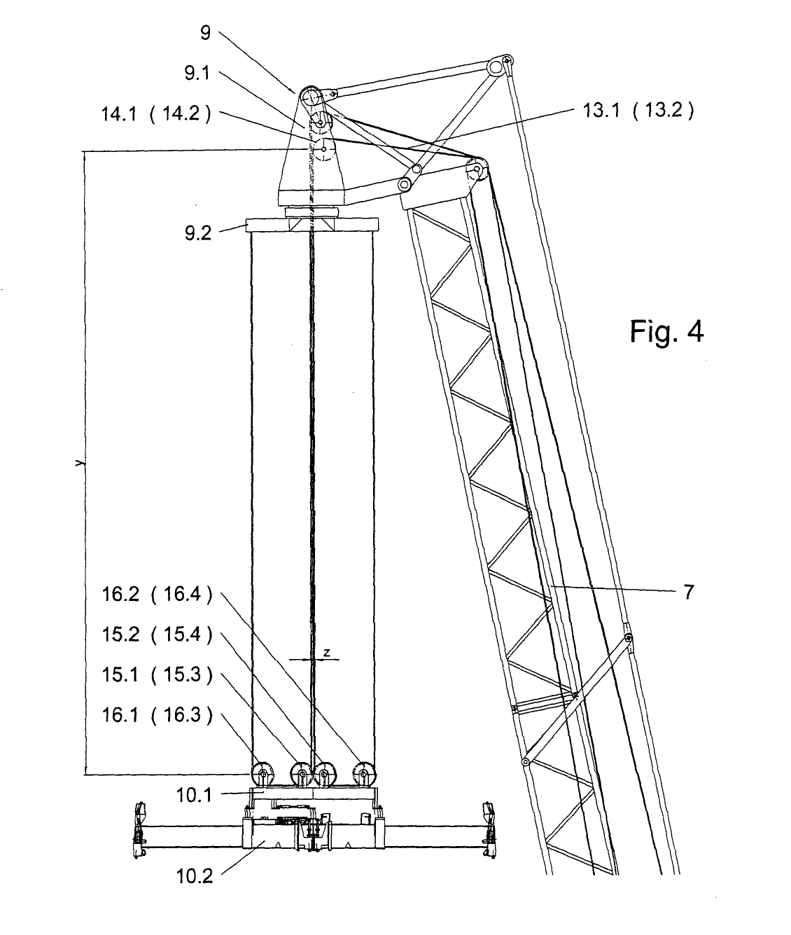

Illustration FIG. 4 shows the same situation as FIG. 3, however, now the lower rotary part 9.2 of boom head 9 is shown with a rotary offset of 90° with regard to luffing upper part 9.1. The distance of the rolls of rope “z” of rolls of rope 14.1 and 14.2 and axis distance “y” between rolls of rope 14.1 and 14.2 in the upper part of boom head 9.1 and rolls of rope 15.1-15.2 on load traverse 10.1 of the load-handling device are constructively chosen such that the rope diversion of hoisting ropes 13.1 and 13.2 is in the permitted range. Spreader 10.2, telescoped in a maximum position of 45 ft., still has a sufficient clearance to boom 7 in its vertical position while at maximum hoisting height.

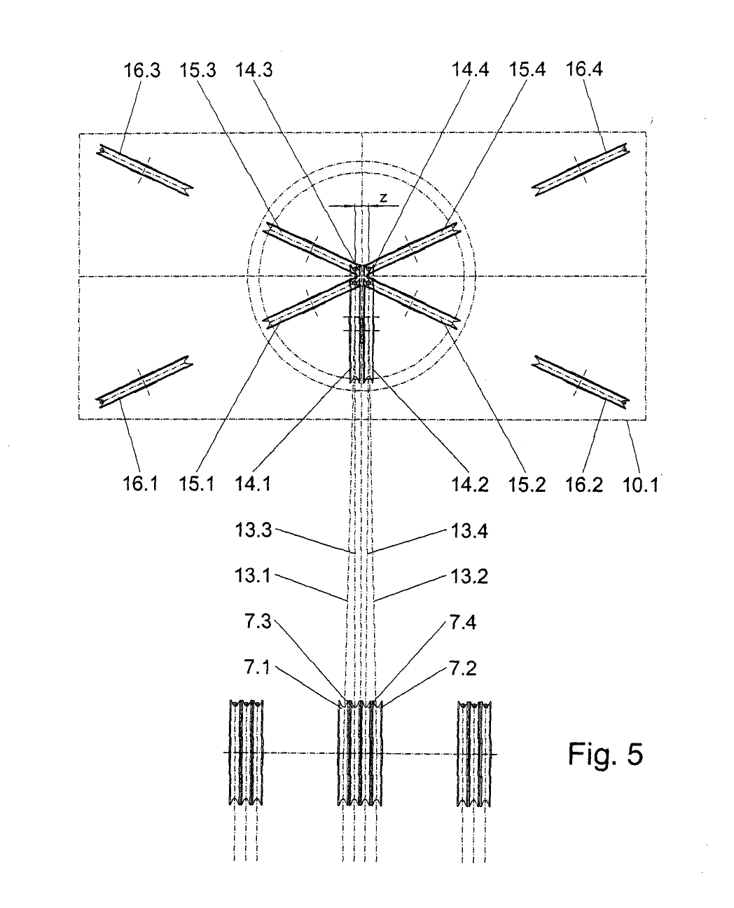

FIG. 5 schematically shows the routing of the hoisting ropes in a top view onto the luffing head from FIG. 3. Via the four rolls of rope 7.1-7.4, the four hoisting ropes 13.1-13.4 are routed by means of the two pairs of rolls of rope 14.1 and 14.2 as well as 14.3 and 14.4 vertically (vertical to the drawing plane) in the direction of load traverse 10.1, subsequently via rolls of rope 15.1-15.4, which are arranged in an x-shape, from there via rolls of rope 16.1-16.4, located on the same plane and arranged in an x-shape. The drawing's illustration shows the lower part 9.2 of boom head 9 without rotary offset to the fixed upper part 9.1 in a 0° position.

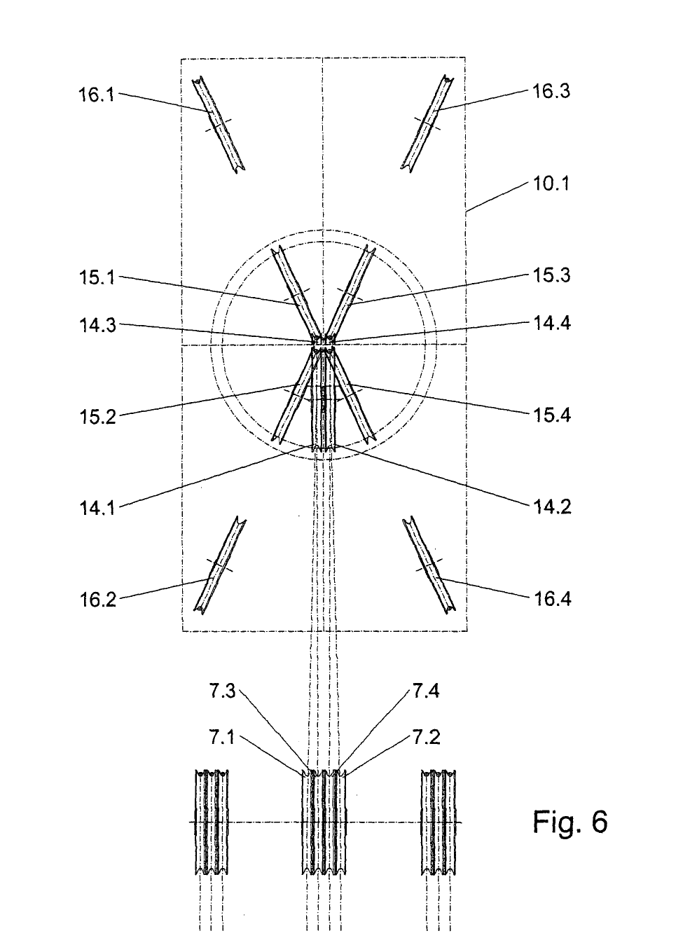

FIG. 6 also shows a top view onto the boom head from FIG. 4 in a schematic illustration. The routing of the rope corresponds to the description of the drawing in FIG. 5. The figure principally shows the same situation as in FIG. 3, however, rotary part 9.2 is now depicted with a rotary offset of 90° to luffing component 9.1.

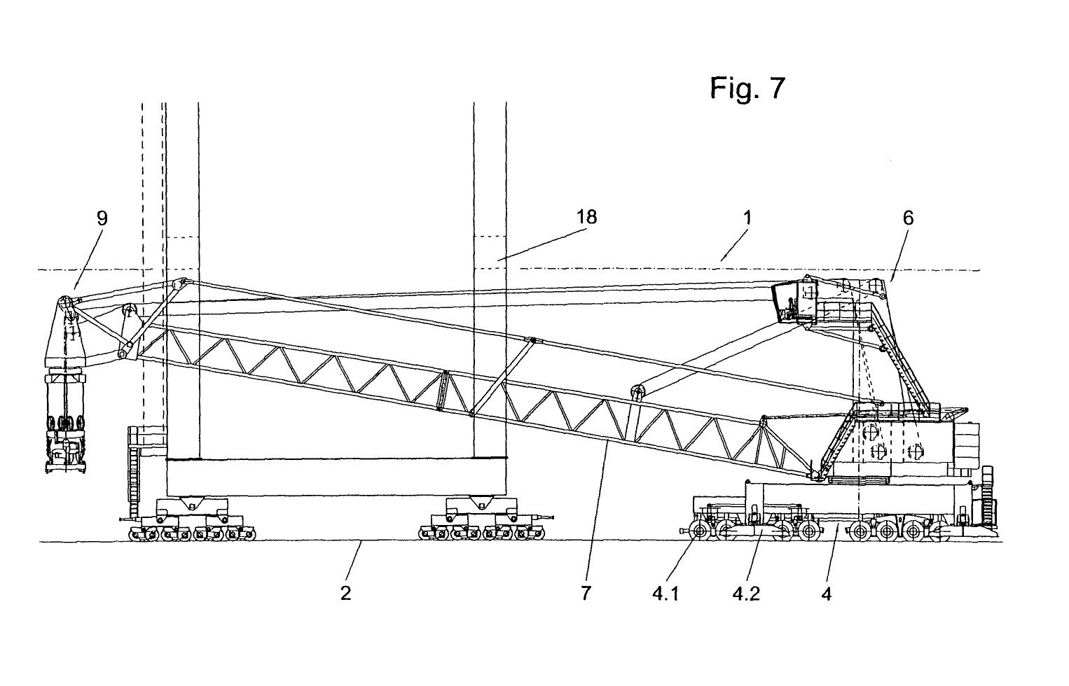

FIG. 7 shows a mobile harbor crane according to the invention in a transport position from a lateral view traveling on wharf 2 through the portal of container bridge 18. For an even axle load distribution, the axles in wheel mechanism 4.1 of lower carriage 4 are divided at a ratio of “four to two+two” and balanced. Boom 7 with its luffing boom head 9 is lowered to the same level as the top of tower 6 in the direction of axle group “two+two”, support 4.2 is retracted, respectively telescoped.

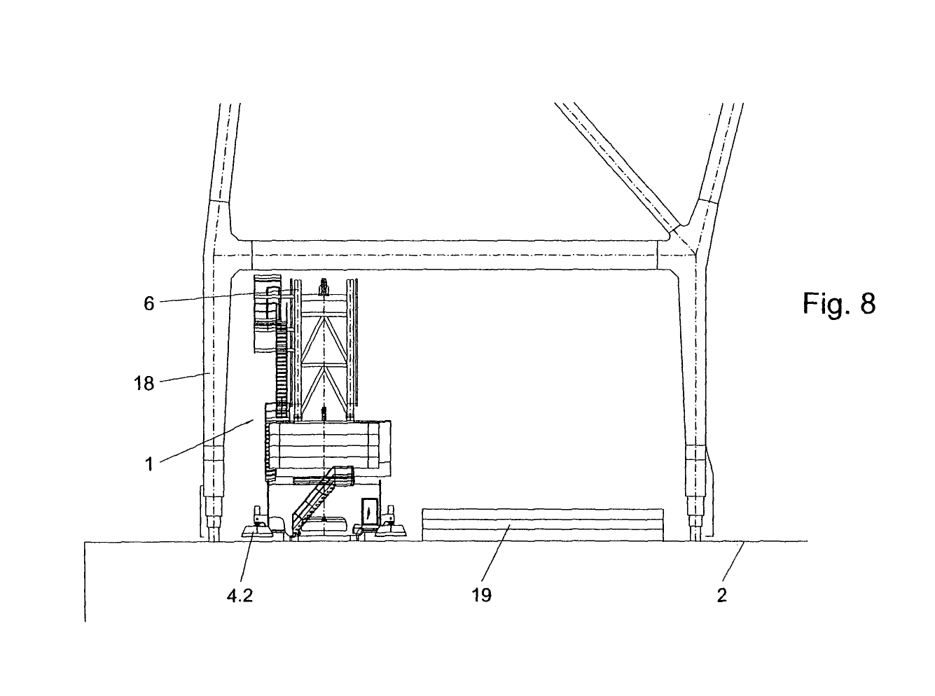

As can be seen in drawing FIG. 8, the dimensions of a mobile harbor crane according to the invention also permit the equipment to pass between the supports of a container bridge, even if a ship's hatch covers are stored there. Additional lanes next to a container bridge are not necessary.

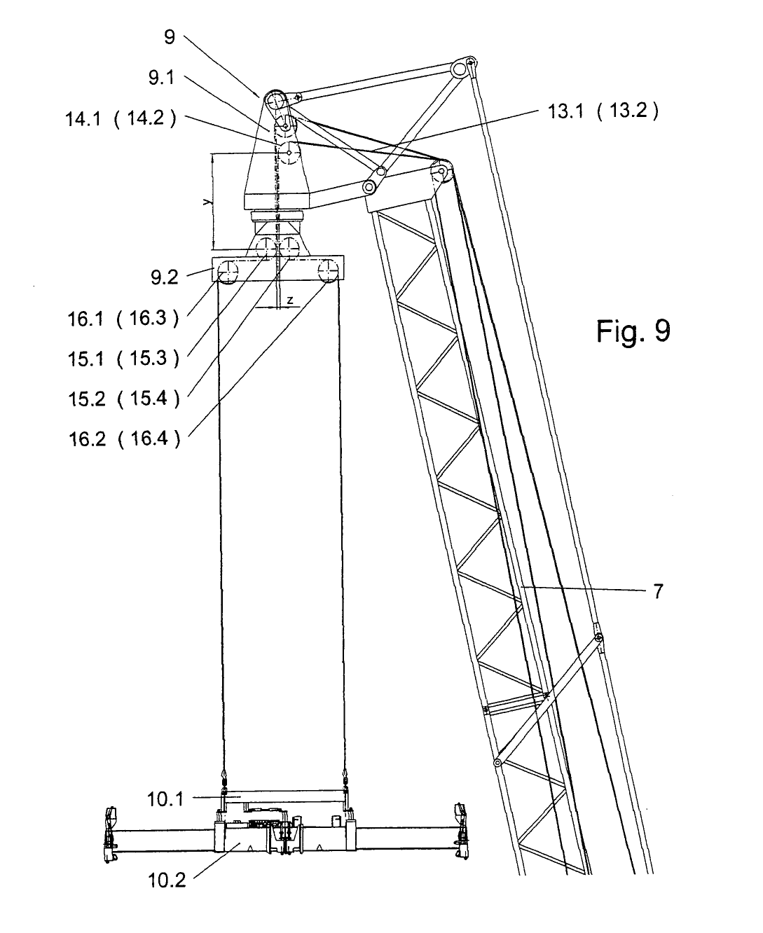

One alternative routing of hoisting ropes on a mobile harbor crane according to the invention is shown in the drawing in FIG. 9. From a cross-sectional view, the routing of rope corresponds essentially to the illustration in FIG. 4, however, hoisting ropes 13.1 and 13.2 are reeved three times between the tower and the tip of the boom. By means of the four rolls of rope 7.1-7.4, hoisting ropes 13.1-13.4 are routed via the two pairs of rolls of rope 14.1 and 14.2 as well as 14.3 and 14.4 and subsequently via rolls of rope 15.1-15.4, which are located on the upper plane in an x-shape. From there, the hoisting ropes are routed via rolls of rope 16.1-16.4, located on the lower plane in an x-shape, to suspension points 17.1-17.4 of load traverse 10.1.

Changes and modifications in the specifically described embodiments can be carried out without departing from the principles of the invention which is intended to be limited only by the scope of the appended claims, as interpreted according to the principles of patent law including the doctrine of equivalents.

The embodiments of the invention in which an exclusive property or privilege is claimed are defined as follows:

1. A mobile harbor crane as mobile handling equipment for piece goods, specifically to handle ISO containers from smaller container ships; comprising:
a lower carriage with a steerable wheel mechanism with multiple axles and supports that can be telescoped laterally and an upper carriage that is a base for a luffing boom with a load-handling device mounted on said boom;
said upper carriage holding a rigid tower, drive aggregates and a counterweight, said upper carriage connected to the lower carriage via a slewing gear;
said boom being articulated in a luffing manner to a lower section of said upper carriage and holding at a tip of said boom a boom head to which a load-handling device is fastened via hoisting ropes.

2. The mobile harbor crane according to claim 1, wherein said boom head is connected to the tip of said boom via a parallelogram system and remains oriented vertically and horizontally during luffing in every boom position by means of support poles or holding ropes.

3. The mobile harbor crane according to claim 2, wherein said boom head comprises two pieces in a horizontal direction, said two pieces comprising an upper first part which is connected to the luffing boom by means of said parallelogram system and a lower second part which is connected to the upper part via a horizontal rotary connection.

4. The mobile harbor crane according to claim 3, wherein said boom head has a lower part which is pivoted around a vertical axis of rotation and can be turned via rotary drives by up to ±135° compared to a fixed upper part of said boom head.

5. The mobile harbor crane according to claim 4, wherein, in order to raise and lower a load-handling device, a total of four hoisting ropes that are reeved five times between the tower and the tip of the boom are routed concentrically via four rolls of rope located at the tip of the boom to two pairs of rolls of rope located in the upper part of the boom head, one staggered above the other pair such that the four hoisting ropes run parallel and at the same distance to each other vertically central through rotary connection to said load-handling device, where said hoisting ropes are routed via four vertically revolving deflection rollers fastened there in a star shape outward to one each of four additional deflection rollers mounted on said load-handling device and guiding the respective said hoisting rope vertically upward back to the pivoted lower part of the boom head, where said four hoisting ropes are fastened.

6. The mobile harbor crane according to claim 1, wherein, in order to raise and lower said load-handling device, a total of four hoisting ropes that are reeved three times between said tower and the tip of said boom, are routed concentrically via four rolls of rope located on the tip of said boom to two pairs of rolls of rope located in the upper part of the boom head, of which one pair is staggered above the other pair such that the four hoisting ropes run parallel and at the same distance to each other and vertically central through said rotary connection into the lower part of said boom head, where said hoisting ropes are routed by means of four vertically revolving deflection rollers in a star shape outward to one each of four additional deflection rollers, which guide the respective said hoisting rope vertically downward to one of the corner areas of said load-handling device.

7. The mobile harbor crane according to claim 6, wherein a distance between a lower of the two pairs of rolls of rope located in said upper part of said boom head and said four vertically revolving deflection rollers located in the lower part of said boom head is chosen such that the permitted rope diversion does not exceed 4° when turning the lower part of said boom head.

8. The mobile harbor crane according to claim 1, wherein said boom with said articulated boom head can be pivoted into a lower transport position, in which the tip of said boom is located below an assumed horizontal plane, which makes contact with the top of said tower of said mobile harbor crane.

9. The mobile harbor crane according to claim 1, wherein, in order to increase the support base of the mobile harbor crane for travel in one direction, the axles of said wheel mechanism of the lower carriage with regard to the center of said rotary mechanism between the upper carriage and the lower carriage of said mobile harbor crane are arranged asymmetrically.

10. The mobile harbor crane according to claim 9, wherein a total of eight axles are designated for a wheel mechanism and are divided at a ratio of “4 to 2 plus 2” and that in order to move said mobile harbor crane, said boom can be lowered in the direction of axle group “2 plus 2.”

11. The mobile harbor crane according to claim 1, wherein said boom head comprises two pieces in a horizontal direction, said two pieces comprising an upper first part which is connected to the luffing boom by means of said parallelogram system and a lower second part which is connected to the upper part via a horizontal rotary connection.

12. The mobile harbor crane according to claim 11, wherein said boom head has a lower part which is pivoted around a vertical axis of rotation and can be turned via rotary drives by up to ±135° compared to a fixed upper part of said boom head.

13. The mobile harbor crane according to claim 12, wherein, in order to raise and lower a load-handling device, a total of four hoisting ropes that are reeved five times between the tower and the tip of the boom are routed concentrically via four rolls of rope located at the tip of the boom to two pairs of rolls of rope located in the upper part of the boom head, one staggered above the other pair such that the four hoisting ropes run parallel and at the same distance to each other vertically central through rotary connection to said load-handling device, where said hoisting ropes are routed via four vertically revolving deflection rollers fastened there in a star shape outward to one each of four additional deflection rollers mounted on said load-handling device and guiding the respective said hoisting rope vertically upward back to the pivoted lower part of the boom head, where said four hoisting ropes are fastened.

14. The mobile harbor crane according to claim 2, wherein said boom with said articulated boom head can be pivoted into a lower transport position, in which the tip of said boom is located below an assumed horizontal plane, which makes contact with the top of said tower of said mobile harbor crane.

15. The mobile harbor crane according to claim 3, wherein said boom with said articulated boom head can be pivoted into a lower transport position, in which the tip of said boom is located below an assumed horizontal plane, which makes contact with the top of said tower of said mobile harbor crane.

16. The mobile harbor crane according to claim 2, wherein, in order to increase the support base of the mobile harbor crane for travel in one direction, the axles of said wheel mechanism of the lower carriage with regard to the center of said rotary mechanism between the upper carriage and the lower carriage of said mobile harbor crane are arranged asymmetrically.

17. The mobile harbor crane according to claim 3, wherein, in order to increase the support base of the mobile harbor crane for travel in one direction, the axles of said wheel mechanism of the lower carriage with regard to the center of said rotary mechanism between the upper carriage and the lower carriage of said mobile harbor crane are arranged asymmetrically.
